(19) United States
(12) Patent Application Publication
(10) Pub. No.: US 2014/0319251 A1
(43) Pub. Date: Oct. 30, 2014

(54) Agricultural harvesting machine

(71) Applicant: CLAAS SELBSTFAHRENDE ERNTEMASCHINEN GMBH, Harsewinkel (DE)

(72) Inventor: Manfred Pollklas, Rheda-Wiedenbrueck (DE)

(73) Assignee: CLAAS SELBSTFAHRENDE ERNTEMASCHINEN GMBH, Harsewinkel (DE)

(21) Appl. No.: 14/254,116

(22) Filed: Apr. 16, 2014

(30) Foreign Application Priority Data
Apr. 24, 2013 (DE) 102013104121.3

(51) Int. Cl. A01F 29/14

(52) U.S. Cl. CPC A01F 29/14
USPC 241/33; 241/152.1

(57) ABSTRACT

An agricultural harvesting machine embodying a self-propelled forage harvester is equipped with a shredding assembly for the continuous shredding of crop conveyed as a crop stream through the shredding assembly and a recutter disposed downstream of the shredding assembly relative to the direction of crop flow that comprises at least one cutting element that is moveable into and out of the crop stream. A control device that is operated via actuation of an actuator assigned to the cutting element to move the cutting element out of an inactive position (P₀) in which the cutting element is ineffective relative to the crop stream into at least one active position (P₁) in which the cutting element extends into the crop stream effectively imposing a shredding effect on the crop.

### CROSS-REFERENCE TO A RELATED APPLICATION

The invention described and claimed hereinbelow is also described in German Priority Document DE 10 2013 104121.3, filed on Apr. 24, 2013. The German Priority Document, the subject matter of which is incorporated herein by reference, provides the basis for a claim of priority of invention under 35 U.S.C. 119(a)-(d).

### BACKGROUND OF THE INVENTION

The invention relates to an agricultural harvesting machine, in particular a self-propelled forage harvester.

Agricultural harvesting machines such as forage harvesters are equipped, inter alia, with a chopping assembly, which is used to shred crop that has been picked up from the field into particles of a desired size. This takes place continuously in that the chopping assembly comprises a chopper drum equipped with knives. The chopper drum rotates relative to a stationary shear bar and, therefore, crop conveyed into the chopping assembly is continuously shredded via the interaction of the shear bar and the chopping knives that move past this shear bar, thereby being “chopped”. Due to the high peripheral speed of the knives, the chopped crop subsequently emerges from the chopping assembly at a high rate of speed. This speed is so high that, after passing through a conveyor chute, the crop stream can emerge from the forage harvester above the machine housing. An additional discharge accelerator is usually provided in order to ensure that the crop is reliably discharged through a transfer device.

The high kinetic energy possessed by the crop after passing through the chopping assembly is utilized according to DE 44 44 054 A1. The aforementioned document describes the possibility of installing recutter having cutting elements, which extend into the crop stream, downstream of the chopping assembly relative to the direction of flow of the crop, in order to further shred the crop that has already been chopped and accelerated by the chopping assembly. The objective of this recutting is chopping up leaves (husk leaves, for example) and/or stalks that passed through the chopping assembly unchopped, which can occur due to the position of these unchopped stalks upon entry into the chopping assembly. To this end, the recutter according to DE 44 44 054 A1 comprises a carrier equipped with a plurality of cutting elements. The carrier, including the cutting elements mounted thereon, can be swivelled vertically about a pivot axis and removed. The cutting elements are rigidly mounted on the carrier. If the efficacy of the cutting elements should change relative to the crop stream, the position of the carrier must also change, wherein this carrier shields the chopper drum on the underside thereof and simultaneously functions as a wall of the chopper drum that guides the crop. An adjustment therefore strongly influences the course of the crop stream. The efficacy of the recutter cannot be changed during operation.

### SUMMARY OF THE INVENTION

The present invention overcomes the shortcomings of known arts, such as those mentioned above.

To that end, the present invention provides a harvesting machine with which additional shredding of the chopped crop is achieved without thereby impairing the course of the crop stream. Moreover, an operator of the harvesting machine is provided with the opportunity to affect the efficacy of the additional shredding during the harvesting operation, in particular in order to ensure he or she can respond to conditions that change during the harvesting operation.

The aforementioned problem is solved by a harvesting machine constructed according to the inventive principles and including a control device that is operated to bring the cutting element out of an inactive position (in which the cutting element is ineffective relative to the crop stream), via actuation of an actuator assigned to the cutting element, into at least one active position. In the at least one active position, the cutting element extends into the crop stream such that this cutting element exerts a shredding effect on the crop.

Also according to the invention, it is possible, advantageously, to change the shredding effect exerted on the crop during the harvesting operation. Given that the cutting element can be moved by an actuator relative to the crop stream, the course of the crop stream can remain unchanged to the greatest extent possible and independently of the position of the cutting element. Given that the actuator is controlled by the control device, actuation is performed by the driver of the harvesting machine in a convenient manner from the driver's cab, for example, and/or is implemented automatically without the need to perform retrofitting and/or to implement an adjustment manually. Since the efficacy of the at least one cutting element is adjusted during operation, a more efficient harvesting operation overall is made possible, since the cutting element then needs to be implemented only when this is advantageous for the harvesting process.

The invention can be used on diverse types of harvesting machines that have a comparable shredding assembly: Advantageously, the shredding assembly is a chopping assembly comprising a chopper drum, which is equipped with knives and can be driven so as to rotate relative to a stationary shear bar.

In terms of design, it is advantageous that the at least one cutting element has a cutting edge. As such, when the cutting element assumes an active position, this cutting edge is disposed such that the crop emerging from the shredding assembly impacts this cutting edge.

In an embodiment, a guide element comprising a curved guide plate for guiding the crop stream is disposed downstream of the shredding assembly relative to the direction of crop flow. At least one opening is provided in the guide element, through which the at least one cutting element is brought out of the inactive position, in which the cutting element lies virtually behind the guide element, into the active position, in which the cutting element protrudes from the guide element.

In an arrangement, the actuator brings the at least one cutting element out of exactly one inactive position and into exactly one active position. The flexibility of the usability can be increased when the actuator is operated to bring the at least one cutting element into various active positions that are characterized by efficacies that differ in terms of the shredding of the crop. In particular, the various active positions therefore differ in terms of different depths of penetration by the cutting element into the crop stream.

In order to achieve a reliable and consistent shredding effect, the recutter comprises a plurality of cutting elements that are preferably disposed next to one another (relative to the width of the crop stream) relative to the direction of the crop stream. It is thereby made possible for the crop to be consistently fed to the active region of the cutting elements not only partially but entirely, whereby consistent shredding takes place.

Moreover, a device for selecting a desired number of cutting elements to be activated is provided in order to make it possible to achieve shredding effects that differ, for example, depending on the particular harvesting conditions.

In the simplest case, the control device is a manual control device that the operator of the harvesting machine can actuate, for example, by pressing a button and/or via an operator terminal. In this case, the operator makes his own decision regarding the setting of the recutter.

Alternatively, the control device is configured to operate automatically, in order to further relieve the driver and/or to prevent miscalculations on the part of the operator. In this sense, the control device could be advantageously operated to automatically control the actuator for adjusting the at least one cutting element depending on operating parameters of the harvesting machine. Various operating parameters could be utilized therefor.

The control device also could be used to prevent activation of the cutting element in the event that certain operating parameters are present, in particular, when a predefinable length of cut is exceeded. In this manner, the risk of assemblies becoming clogged, which exists in the case of long lengths of cut, is markedly reduced.

The control device also could be operated to bring all cutting elements into the inactive position, at least temporarily, within the scope of a cleaning procedure. This is preferably triggered by predefinable operating situations (e.g., when the headland is reached, at machine start-up, at the end of operation, when intake stops, when the machine has no throughput, upon activation of the cutting elements). In this manner, the cutting elements are cleaned automatically in a particular operating situation, thereby relieving the machine operator of this task. The cleaning effect advantageously results in that contamination adhering to the cutting elements is wiped off by the movement into the active position.

In an embodiment, the control device has a signal connection to at least one sensor for detecting properties of the crop and can be operated to control the actuator for adjusting the at least one cutting element depending on crop properties detected by sensors. The crop properties can be various properties. Advantageously, this is at least the dry mass of the crop. The objective here is to increase the intensity of the shredding effect by the recutter as the portion of dry mass of the crop increases, in order to respond to the situation in which the crop (corn, in particular) tends to comprise a greater portion of husk leaves and stalks when the crop is drier.

Various types of sensors can be used therefor. The sensor may comprise an optical sensor such as a camera that optically detects the conveyed crop, a spectroscope (near-infrared sensor) functioning in the near-infrared range, and/or a conductance sensor. Entirely generally, the sensor can be suitable for detecting properties such as the moisture content and/or the ingredients and/or the length of cut of the crop.

### BRIEF DESCRIPTION OF THE DRAWINGS

Further features and advantages of the invention will become apparent from the description of embodiments that follows, with reference to the attached figures, wherein:

FIG. 1 presents a self-propelled forage harvester in a schematic side view that is configured for implementing the invention.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

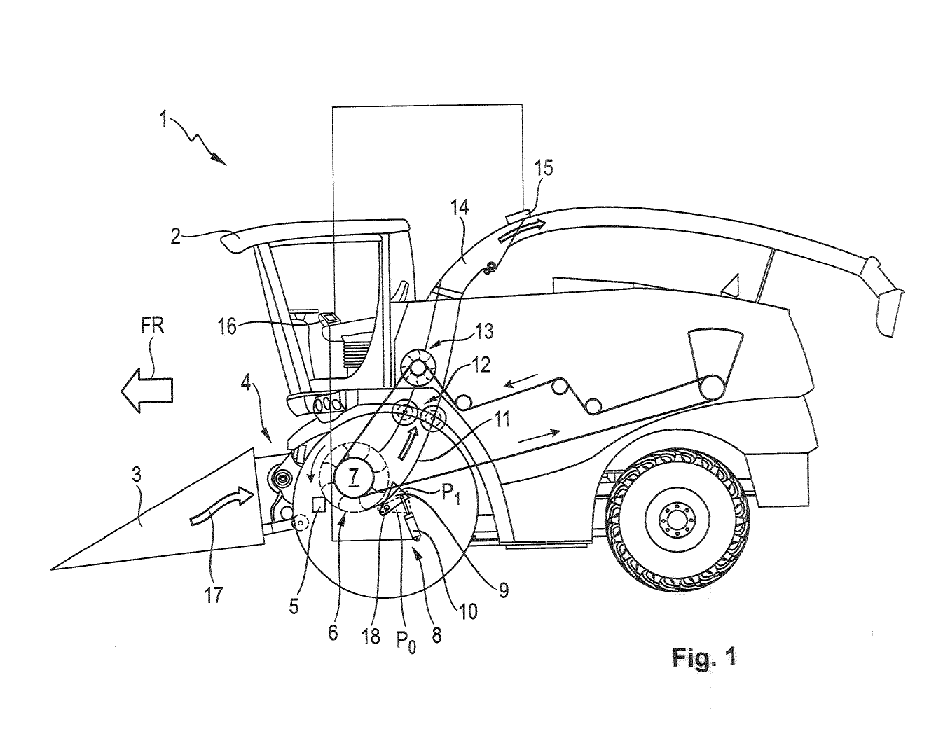

FIG. 1, the sole figure, shows an agricultural harvesting machine in the form of a forage harvester 1 in a schematic side view from the left, relative to a direction of travel FR indicated by an arrow. The forage harvester 1 comprises a driver's cab 2 in a typical manner per se, in which a driver can sit in order to operate the forage harvester 1 during the harvesting operation. Operation takes place, inter alia, via an operating, display, and control device 16 disposed in the cab 2. A front harvesting attachment 3 is mounted on the front side of the forage harvester 1, which is used to sever a plant stand (which is growing and is intended for harvest) from the field and convey said plant stand to the further conveying and working assemblies of the forage harvester 1. According to a typical application, the forage harvester 1 is used to harvest corn.

After the crop is picked up by the front harvesting attachment 3, the crop passes through the forage harvester 1 as a continuous crop stream 17, as indicated by a plurality of arrows shown in the machine. First, the crop stream is precompressed in an intake assembly 4 equipped with a plurality of compression rollers. Next, the crop enters a chopping assembly 7. This substantially comprises a chopper drum 6, which rotates in the direction indicated by an arrow, is equipped with a plurality of chopping knives and comprises a shear bar 5 that is stationary relative to the chopper drum 6. By interaction of the shear bar 5 and the chopping knives moving past this shear bar, the passing crop is shredded (i.e., chopped), in the active region between the shear bar 5 and the chopper drum 6. Due to the high peripheral speed of the chopper drum 6 and, therefore, of the chopping knives, the crop emerges from the chopping assembly 7 at a high rate of speed.

Also, a conditioning device 12 is preferably disposed downstream of the chopping assembly 7. The conditioning device has two oppositely driven conditioning rollers, for example, in order to further fragmentize the crop in a processing gap formed between these conditioning rollers for the purpose of ensuring better digestibility by animals or to otherwise increase quality.

A discharge accelerator 13 is used to further increase the speed of the crop stream 17, in order to ensure that the crop is reliably discharged through an upper discharge chute 14 disposed on the top side of the machine.

A recutter 9 is disposed downstream of the chopping assembly 7 of the forage harvester 1 (relative to the direction of the crop stream 17). The recutter has at least one cutting knife 9 that can be brought into the crop stream 17. To this end, a guide plate 11, which bounds the crop stream 17 on the underside, is equipped with one (slot type) opening for each cutting knife 9, through which the cutting knife 9 can extend into the crop stream 17. The cutting knife 9 advantageously has a cutting edge, which is disposed such that the crop emerging from the chopping assembly 7 impacts this cutting edge (at least partially) when the cutting knife 9 is activated. Due to the high kinetic energy of the crop, a flying cut occurs at the cutting edge. The flying cut shreds leaves (husk leaves, for example) contained in the crop and/or stalks that have not already been sufficiently shredded by the chopping assembly.

The at least one cutting knife 9 is supported in a pivot point 18 so as to be rotatable about a pivot axis extending perpendicularly to the longitudinal direction of the machine (corresponding to the direction of travel FR). Due to this pivotable support, the cutting knife 9 is movable between at least one inactive position P₀, in which this cutting knife does not extend into the crop stream 17, into at least one active position P₁, in which the cutting knife 9 extends into the crop stream 17. The cutting knife 9 can assume any position located therebetween, in which the cutting knife 9 extends into the crop stream 17, but the cutting edge of the cutting knife 9 does not have the full effect thereof.

To permit actuation of the cutting knife 9, this cutting knife is operatively connected to an actuator, preferably to an adjusting cylinder 10, in a heel region remote from the pivotal point 18. The adjusting cylinder 10 is controlled by the control device 16. As a result, the forage harvester 1 comprises a control device 16, that is operated to move the (at least one) cutting knife 9, via control of an actuator 10 assigned to the cutting knife 9, out of an inactive position P₀ (in which the cutting knife 9 is ineffective with respect to the crop flow 17), into at least one active position P₁ (in which the cutting knife 9 extends into the crop stream 17) such that this cutting knife exerts a shredding effect on the crop. In the embodiment shown, the inactive position P₀ of the cutting knife 9 results when the adjusting cylinder 10 is retracted. On the other hand, the active position P₁ is reached when the adjusting cylinder 10 is extended.

It should be noted that any other similarly-acting actuator system can be used, of course, by which the cutting knife 9 can be actuated between an inactive state and an active state.

As the FIG. 1 embodiment shows only one cutting knife 9, due to the lateral representation, it should be noted that the recutter 8 comprises a plurality of cutting knives 9 disposed next to one another relative to the direction of the crop stream 17. The cutting knives 9 are coupled to one another via a mechanical system such that the cutting knives are actuated jointly by the adjusting cylinder 10. In addition, the number of cutting knives 9 to be actuated is determined via a selection device, thereby making it possible to utilize a different number of active cutting knives 9 depending on the intended use.

In order to precisely control the shredding effect, the cutting knives 9 are moved by the adjusting cylinder 10 into different active positions (of which only P₁ is shown here, for clarity), which are characterized in that the efficacy thereof differs in terms of shredding the crop.

In one case, the control device 16 is manually actuated by an operator, for example, within the scope of a manual operating mode. The operator then actively influences the state of activation of the cutting knives 9 by deciding for himself whether and to what extent to activate the cutting knives 9.

Alternatively, or in addition thereto, the control device 16 controls the adjusting cylinder 10 for actuating the cutting knives 9 depending on operating parameters. These can be highly diverse parameters, which can be significant for the state of activation of the cutting knives 9.

For example, the forage harvester 1 comprises a sensor 15 for detecting properties of the crop, wherein this sensor has a signal connection to the control device 16. In the embodiment shown, the sensor 15 is an optical sensor. This optical sensor is disposed on the upper discharge chute 14 and is oriented so as to optically detect crop moving past this optical sensor. A signal evaluation is performed in order to deduce the properties of the crop, such as the moisture content (or the dry-mass substance) thereof, ingredients, length of cut, raw ash content, and/or others.

The optical sensor is preferably a camera and/or a near-infrared sensor. As an alternative to, or in addition to optical sensors, further sensors can be used to determine properties of the crop, such as a conductance sensor for detecting the moisture content (or dry-mass substance) of the crop.

In order to improve the crop quality, the control device 16 increases the efficacy of the cutting knives 9, in particular as the dry-mass substance increases. The reason is that, when harvesting corn, in particular, having a large portion of dry mass in the crop, a large portion of husk leaves and/or unshredded stalks is disruptive. Precisely these portions of husk leaves and/or stalk pieces can be effectively reduced in size by targeting shredding.

Independently of the type of sensor system used, the control device 16 is used to adjust the cutting knives 9 into a respectively suitable position depending on properties of the crop. In the case of continuous detection of these properties, the knife position can therefore be automatically adjusted during an on-going harvesting operation, thereby enabling the cutting knives 9 to be utilized in a manner that is particularly well-suited for the purpose. The knife wear and the energy required by the harvesting machine (fuel consumption) is therefore advantageously reduced.

In order to protect the forage harvester 1 against the crop bale chamber becoming blocked with crop (“seizing”), the control device 16 is operated such that activation of the cutting knives 9 is prevented if certain operating parameters are present. This is advantageous when a predefinable length of cut is exceeded, since the risk of blockage caused by crop increases as the length of crop increases. Other operating parameters that prevent activation of the cutting knives 9 or at least limit the efficacy thereof are feasible.

Increased operating comfort of the recutter 9 results in that the control device 16 is operated to move all cutting elements 9 into the active position P₀, at least temporarily, within the scope of a cleaning procedure. By “retracting” the cutting knives 9 into the inactive position P₀ in such a manner, these cutting knives undergo self-cleaning (contaminants are wiped off at the knife slots in the guide plate 11), provided these are designed accordingly. Such configuration and operation largely eliminates the need for time-consuming manual cleaning. Particularly advantageously, such a self-cleaning procedure is automatically triggered in certain operating situations (event-coupled, in particular). For example, the cleaning procedure is automatically triggered when the end of the field is reached, when the chopper drum drive is shut off, when the crop flow is interrupted, or the like.

The control device 16 disposed in the driver's cab 2 comprises an operating device and a display unit. These are used to display to the driver the activation state and, optionally, the exact penetration depth of the cutting knives 9.

### LIST OF REFERENCE CHARACTERS

1 forage harvester
2 driver's cab
3 front harvesting attachment
4 intake assembly
5 shear bar
6 chopper drum
7 chopping assembly
8 recutter
9 cutting knife
10 adjusting cylinder
11 guide plate
12 conditioning device
13 discharge accelerator
14 upper discharge chute
15 optical sensor
16 operation, display, and control unit
17 crop stream
18 pivotal point
P₀ inactive position
P₁ active position
FR direction of travel

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. An agricultural harvesting machine configured as a self-propelled forage harvester, comprising:
a shredding assembly for the continuous shredding of crop conveyed as a crop stream through the shredding assembly;
a recutter disposed downstream of the shredding assembly relative to the direction of crop flow that comprises at least one cutting element that is moveable into and out of the crop stream; and
a control device that is operated via actuation of an actuator assigned to the cutting element to move the cutting element out of an inactive position (P₀) in which the cutting element is ineffective relative to the crop stream into at least one active position (P₁) in which the cutting element extends into the crop stream effectively imposing a shredding effect on the crop.

2. The harvesting machine according to claim 1, wherein the shredding assembly is a chopping assembly having a chopper drum equipped with knives and driven to rotate relative to a stationary shear bar.

3. The harvesting machine according to claim 1, wherein the at least one cutting element has a cutting edge and wherein in the active position (P₁), the crop emerging from the shredding assembly impacts this cutting edge.

4. The harvesting machine according to claim 1, further comprising a guide element formed as a curved guide plate for guiding the crop stream is disposed downstream of the shredding assembly relative to the direction of crop flow, wherein at least one opening is provided in the guide element through which the at least one cutting element moved out of the inactive position (P₀) and into the active position (P₁).

5. The harvesting machine according to claim 1, wherein the actuator is operated to bring the at least one cutting element into various active positions (P₁) that are characterized by efficacies that differ in terms of the shredding of the crop.

6. The harvesting machine according to claim 1, wherein the recutter comprises a plurality of cutting elements disposed next to one another relative to the direction of the crop stream.

7. The harvesting machine according to claim 1, further comprising a device for selecting a desired number of cutting elements to be activated.

8. The harvesting machine according to claim 1, wherein the control device is configured to be manually actuated by an operator.

9. The harvesting machine according to claim 1, wherein the control device is configured to automatically control the actuator for adjusting the at least one cutting element depending on operating parameters of the harvesting machine.

10. The harvesting machine according to claim 1, wherein the control device is configured to be operated to prevent activation of the cutting element in the event that certain operating parameters are present.

11. The harvesting machine according to claim 10, wherein one of the operating parameters is when a predefinable length of cut is detected to be exceeded.

12. The harvesting machine according to claim 1, wherein the control device is configured to be operated to bring all cutting elements into the inactive position (P₀), at least temporarily, within the scope of a cleaning procedure.

13. The harvesting machine according to claim 12, wherein the cleaning procedure is triggered by predefinable operating situations.

14. The harvesting machine according to claim 1, wherein the control device has a signal connection to at least one sensor for detecting properties of the crop and operates to control the actuator for adjusting the at least one cutting element depending on crop properties detected by the at least one sensor.

15. The harvesting machine according to claim 14, wherein the at least one sensor is an optical sensor comprises one or more optical sensors selected from the group consisting of a sensor camera that optically detects the conveyed crop, a near-infrared sensor and a conductance sensor.

16. The harvesting machine according to claim 1, wherein the control device is configured to control the actuator to adjust the at least one cutting element depending on the dry substance of the crop.
